(19) United States
(12) Patent Application Publication
(10) Pub. No.: US 2017/0307052 A1
(43) Pub. Date: Oct. 26, 2017

(54) MECHANISM FOR MOTION CONVERSION

(71) Applicant: Fahim Mahmood, Sylhet (BD)

(72) Inventor: Fahim Mahmood, Sylhet (BD)

(21) Appl. No.: 15/382,678

(22) Filed: Dec. 18, 2016

Related U.S. Application Data
(60) Provisional application No. 62/325,168, filed on Apr. 20, 2016.

(51) Int. Cl. F16H 21/18

(52) U.S. Cl. CPC F16H 21/18

(57) ABSTRACT

This inventive mechanism relies on to connect a sliding carrier under sliding motion with a rotating crankshaft through a connecting disk or member in order to efficiently convert a reciprocating motion to a rotary motion or vice versa. The connecting disk is generally a uniformly circular disk, pivotally coupled within the sliding carrier and a crankpin of traditional crankshaft is eccentrically coupled with this connecting disk further. Such mechanical setup effectuates the siding carrier along with the connecting disk to slide along the reciprocating motion, rotationally rearrange the connecting disk within the siding carrier in presence of a gripping reaction by the crank pin and enforces the crankshaft to rotate by motion conversion which effectively eliminates a portion of loses in fuel efficiency incurred by the traditional mechanism.

### CROSS-REFERENCE TO RELATED APPLICATIONS

### Statement Regarding Federally Sponsored Research or Development

(Not Applicable)

### REFERENCE TO SEQUENCE LISTING, A TABLE, OR A COMPUTER PROGRAM LISTING COMPACT DISC APPENDIX

(Not Applicable)

### BACKGROUND OF THE INVENTION

This invention is basically best suited in traditional reciprocating engine or in reciprocating compressors where a reciprocating motion is required to convert at a rotary motion or vice versa and it is subsequently an improvement over traditional motion conversion of an ups and down motion of a piston to a rotary motion. This mechanism introduces an innovative concept by which an ordinary skilled person in the art will obviously have a wide range of choices to envisage a device where this mechanism can easily fit into. Even a simple structured opposed type reciprocating engine can also be designed easily by securing two opposed pistons with the sliding carrier, wherein a power density can be enhanced without increasing significant weight, i.e. a power to weight ratio as well as a stroke to bore ratio can be possible to increase significantly without sacrificing the fuel efficiency. Fuel efficiency is vital in engine manufacturing, where about this claimed mechanism is also able to remove loses of efficiency in linkage of a traditional reciprocating engine, thus rendering this mechanism as an efficient and an effective one.

### BRIEF SUMMARY OF THE INVENTION

This mechanism consists of an enclosure or housing where within there is a cavity and it allows the sliding of a sliding carrier. A traditional crank shaft pivotally coupled to the housing, further connected to the sliding carrier through a connecting disk wherein this connecting disk is the core scope of this mechanism which is responsible for vivid change in structural and functional scope compared to traditional mechanism. A forward momentum being engaged in the connecting disk resulting the sliding carrier to have a stroke length two times higher against that of similar sized traditional reciprocating mechanism in one of the cases of this mechanism. This setup of the mechanism correlating its internal parts in such a way that an ups and down motion of a piston fixedly secured to the sliding carrier effectuates the crank shaft to rotate unidirectional with/without the influence of a forward momentum and hence efficient motion transformation can be possible. However a reversal process can also be done if a reciprocating motion is finally desirable from a rotary motion.

### BRIEF DESCRIPTION OF THE SEVERAL VIEWS OF THE DRAWING

Detailed description of the figures are described below.

FIG. 1 represents the front sectional view of this mechanism.

FIG. 2A, FIG. 2B representing a sequential travelling of sliding carrier (3) from TDC to BDC when the crankshaft rotates at rotational direction (20). FIG. 2C, FIG. 2D representing a sequential travelling of sliding carrier (3) from BDC to TDC when the crankshaft rotates at rotational direction (20) wherein Top Dead Centre is traditionally abbreviated as TDC and Bottom Dead Centre is traditionally abbreviated as BDC. This type of motion conversion is appropriate when a radius (ŕ) of a first curved path (14) is greater than a radius (r) of a second curved path (10).

FIG. 3A represents a connecting disk/member (4) having a second pivotal coupling (12).

FIG. 3B represents a sliding carrier (3) having a first pivotal coupling (5).

FIG. 3C represents a traditional crankshaft (9) having a power transmitting shaft (15) and a crank pin (7).

FIG. 4 represents a general form of enclosure or casing (1) with front plate with bearing holder (19) removed for flexibility of exhibition only. It comprises two parallel sliding liners (2) internally, made up of high graphite steel alloy between which the sliding carrier (3) slides and a bearing holder (19) is presented for the coupling with the power transmitting shaft (15).

FIG. 5 represents assembled state of the sliding carrier (3), the connecting disk/member (4) and the crankshaft (9) altogether in the enclosure or casing (1).

FIG. 6 represents another form of motion converting mechanism where a radius (ŕ) of a first curved path (14) is equal to a radius (r) of a second curved path (10) only while all other the generic notations are same as FIG. 1.

FIG. 7A thru FIG. 7B represents a sequential travelling of sliding carrier (3) from TDC to BDC when the crankshaft rotates at rotational direction (20).

FIG. 7C also represents the travelling of sliding carrier (3) from TDC to BDC just before changing sliding direction of sliding carrier (3) from BDC to TDC.

FIG. 7D represents a travelling of sliding carrier (3) from BDC to TDC when the crankshaft rotates at rotational direction (20).

FIG. 8 represents an operational behavior of this mechanism where a radius (ŕ) of a first curved path (14) is equal to a radius (r) of a second curved path (10).

### DETAILED DESCRIPTION OF THE INVENTION

A mechanism for motion conversion that converting a reciprocating motion to a rotary motion or vice versa, comprising an enclosure (1) that accommodates the moving parts responsible for this motion conversion. This enclosure (1) having at least two internal parallel walls facing each other wherein these walls are supporting as well as facilitating a scope for a sliding carrier (3) to slide between said walls with the help of almost frictionless surroundings. An engine oil helps to maintain this frictionless surroundings in the sliding contacts by being saturated therein. There is also a tiny clearance in the sliding contact between the sliding carrier and each said wall wherein this clearance is maintained for lubrication purpose and a value of such clearance generally ranging from 5 to 10 micron of an inch. A sliding liner (2) of the walls is preferably made up of high graphite steel alloy in order to facilitate a smooth and almost frictionless sliding of the sliding carrier (3) wherein this liner acts as a thin layer on the internal parallel walls. This sliding carrier (3) can be secured to any device (such as a piston) which is subjected for reciprocating motion depending upon the use of this mechanism and because of the restriction by the walls, a lateral movement of the secured device can also be prevented, subsequently a wear and tear can also be possible to reduce and improving the sealing system significantly than the existing one.

Inside the sliding carrier (3), a cylindrical void is introduced, that transversely traversing throughout the sliding carrier and this cylindrical void is optimized to have a first pivotal coupling (5) with a connecting disk (4) inside that cylindrical void. This connecting disk/member (4) is preferably a circular profiled plate or disk having an optimum thickness, further being coaxial with a first axis (6). This first axis (6) is basically a central axis of the cylindrical void wherein the whole connecting disk (3) rotates around this first axis (6). So geometrically it is obvious that the first axis is also the central axis of the connecting disk whereby this first axis is affixed with the sliding carrier (3). Although the connecting disk can be of any shape but the whole connecting disk is compulsorily required to be pivoted within the cylindrical void and it can be pivoted by journal bearing or any other bearing in order to facilitate a rotation of the whole connecting disk around the first axis to launch a pivotal connection, i.e. an axis of rotation of the connecting member (4) is required to be coaxial to the first axis (6). That's why this connecting disk is designed to have a circular profile in order to rotate symmetrically within said cylindrical void.

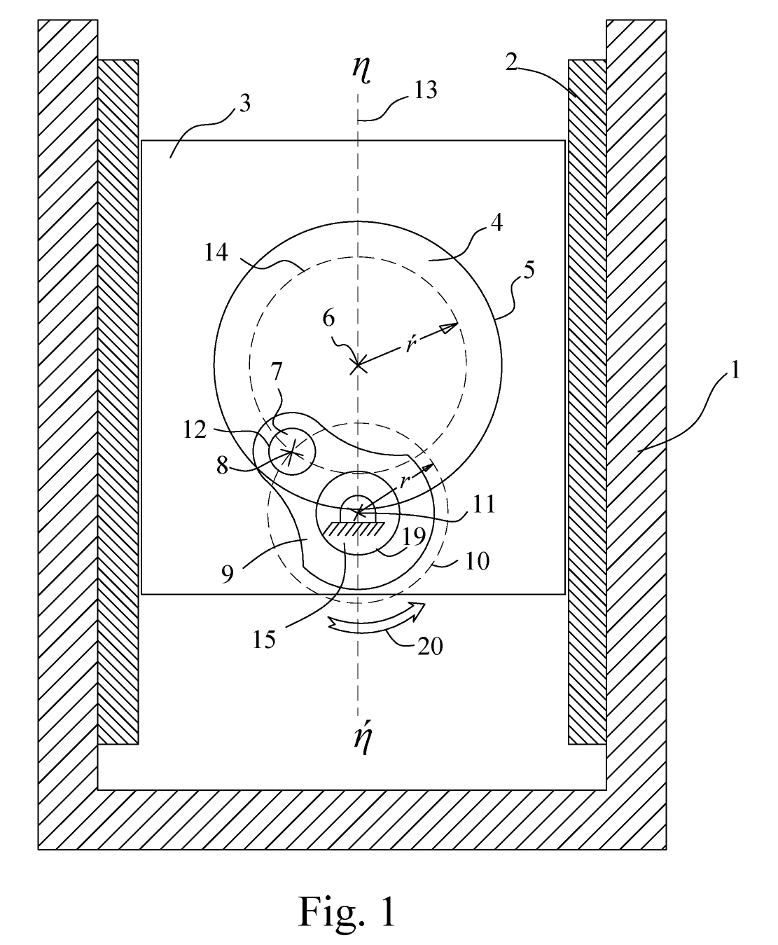

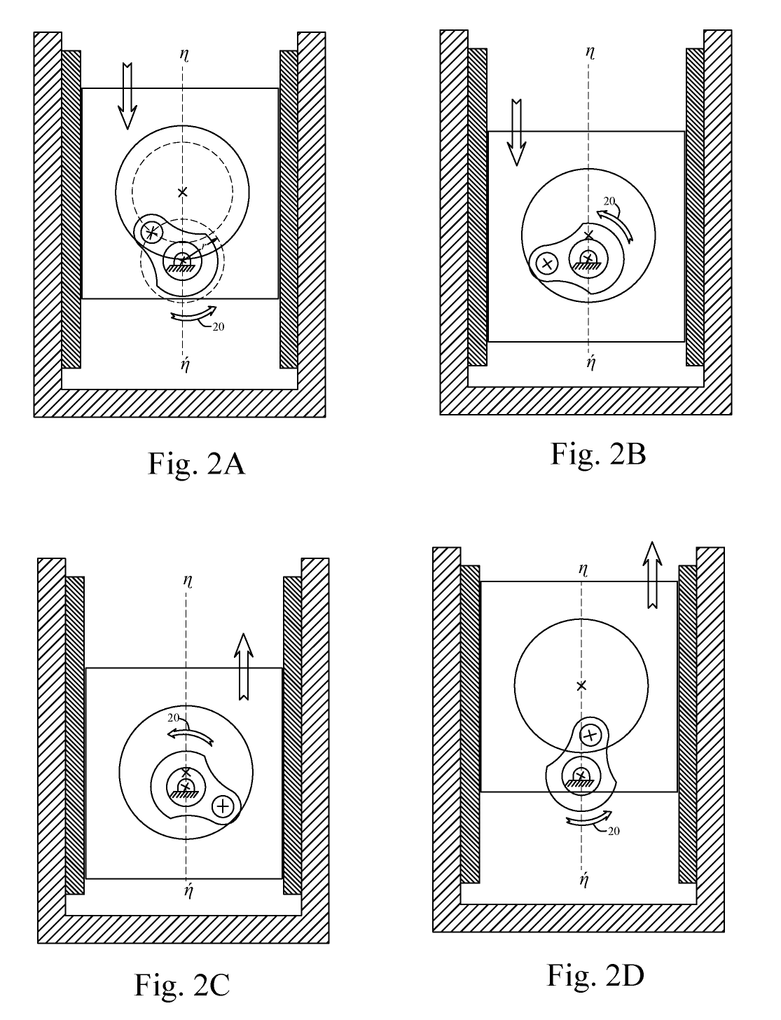

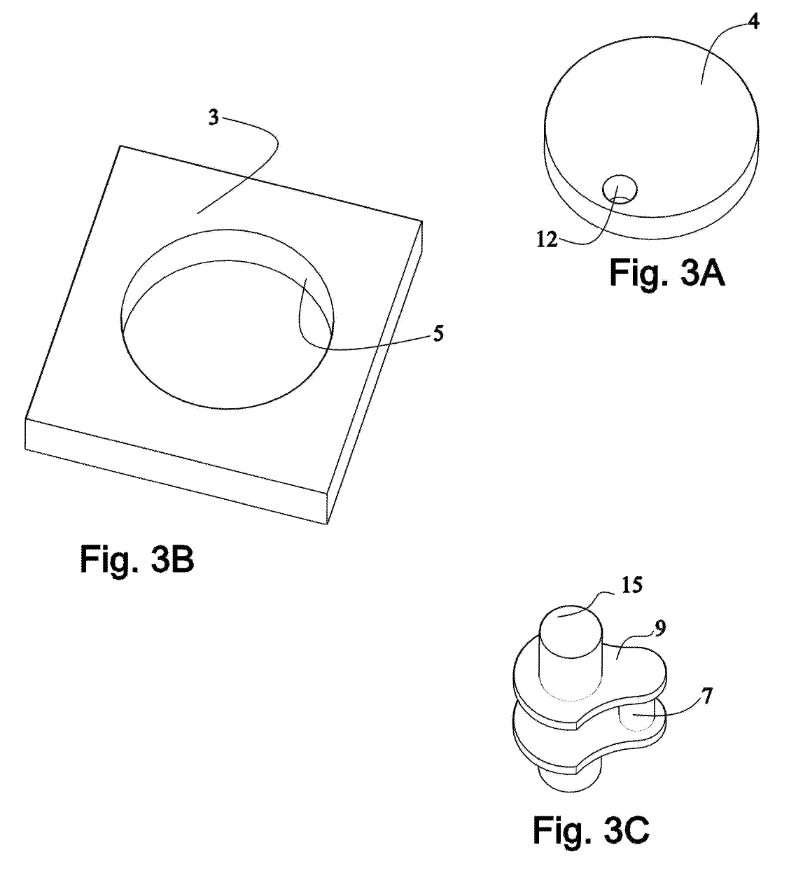

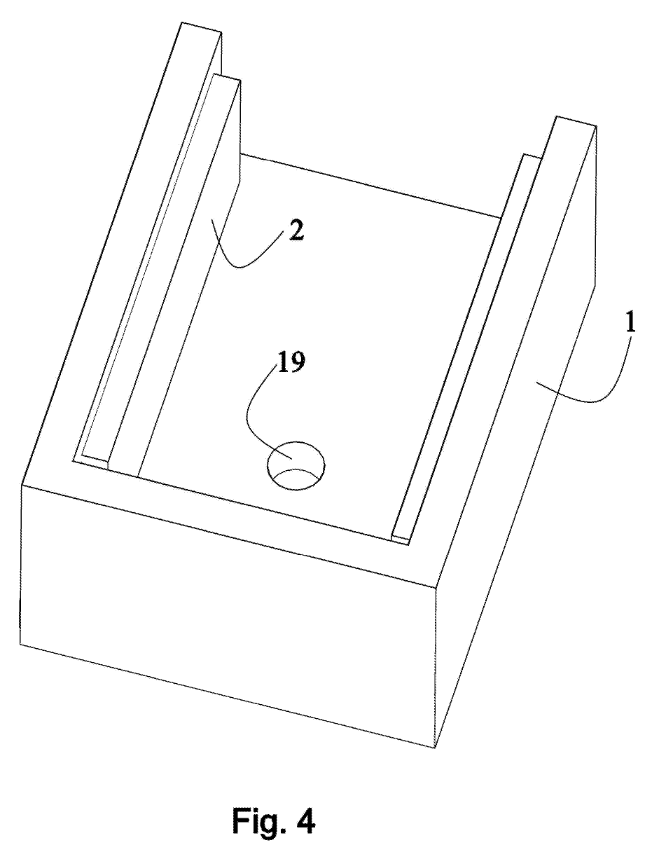

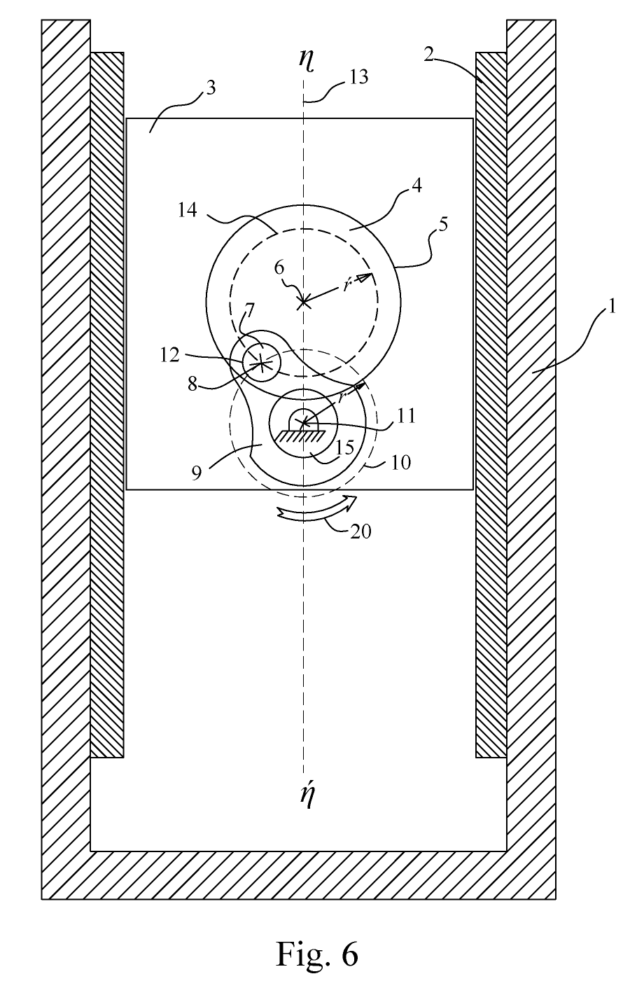

A bearing holder for launching another pivotal connection by a second pivotal coupling (12) is introduced eccentrically and traversing laterally within the connecting disk (4), further having a pivot axis (8) which is the central axis of that bearing holder wherein this second pivotal coupling (12) is within the first pivotal coupling (5). A crankpin (7) is an integral part of a crankshaft (9) wherein this crankshaft is a traditional composite item that is used in traditional reciprocating engine. This crank pin (7) is secured fixedly and eccentrically with respect to a second axis (11) or an axis of rotation of traditional crankshaft (9) where within this crank pin is pivotally coupled to said bearing holder of the connecting disk/member (4) by a bearing or the second pivotal coupling (12). So in view of the current setup, the pivot axis is also the central axis of the crank pin (7) wherein this crank pin rotates around its own axis or the pivot axis (8) and the geometrical setup of this mechanism is such that the pivot axis (8) further rotates around both the first axis (6) and the second axis (11) simultaneously. The aforesaid crankshaft is rotating around the second axis (11) in FIG. 1 or in FIG. 6 and it is pivotally secured to the housing (1) or enclosure by a bearing wherein this second axis (11) is also stationary to the housing (1) consequently.

For perfect working condition of this mechanism; the first axis (6), the pivot axis (8) and the second axis (11) are required to be parallel to each other in a three dimensional work space wherein the first axis (6) and the second axis (11) are aligned within a sliding plane η\acute{η} in FIG. 1 or in FIG. 6. This sliding plane η\acute{η} is not only parallel to the aforesaid internal parallel walls, but also being fixed with the housing (1) wherein the first axis (6) is sliding within this sliding plane η\acute{η}. It is also obvious that as housing is fixed with the sliding plane, so the second axis (11) is also stationary to said sliding plane η\acute{η} and a power transmission is done at power transmitting shaft (15) by a sliding of the sliding carrier (3) along the sliding plane η\acute{η}. Depending on the use of the mechanism, this power transmission can be either positive or negative. While a negative power transmission represents a compression or an exhaust or a suction event and a positive power transmission represents an expansion or a power generating event.

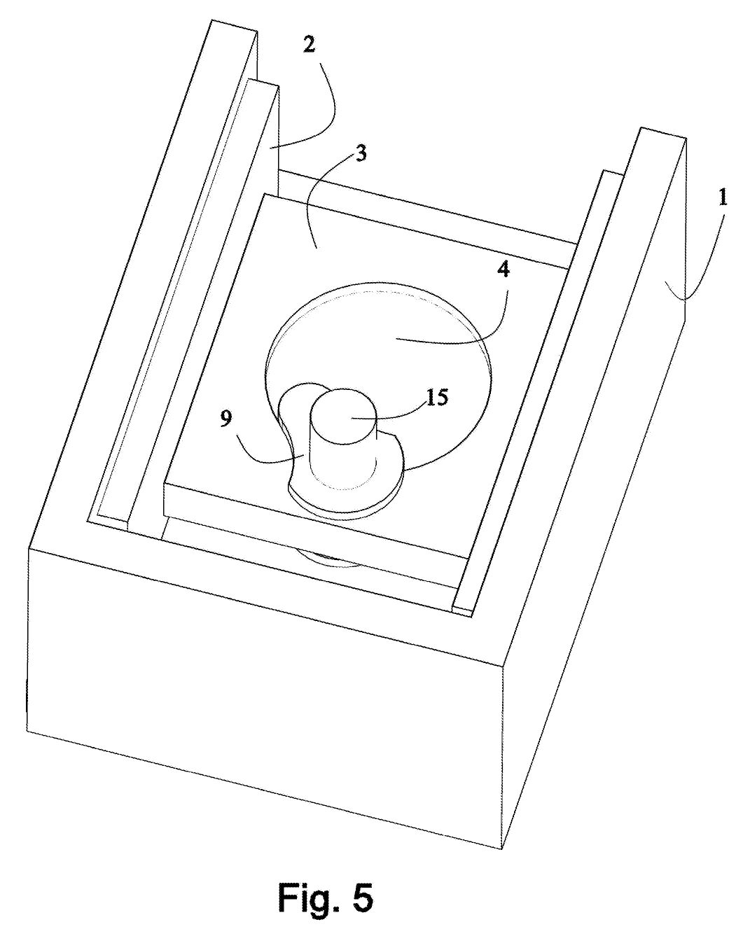

The working principle of this mechanism is pretty straight forward. A thrust from the sliding carrier (3) auto arranges the connecting member (4) rotationally inside the sliding carrier in connection with crankshaft (9) and this auto arrange action enforces the crank pin (7) to propel the crankshaft (9) and vice versa. A rotation of the pivot axis (8) around the first axis (6) defining a first hypothetical curved path (14) having a profile of a circle and a rotation of the pivot axis (8) around the second axis (11) defining a second hypothetical curved path (10) having a profile of another circle. So consequently the above first curved path (14) and the second curved path (10) having a first radius “ŕ” and a second radius “r” respectively in FIG. 1 or in FIG. 6 wherein an equation between the first radius ŕ and the second radius r is critically correlated. A variation in equation between the first radius ŕ and the second radius r thus establishes mainly two different cases. For the first case, wherein the second radius r is smaller than the first radius ŕ in FIG. 1 thru FIG. 5, defining a state of art where the connecting member (4) never completes a full rotation against each full rotation of the crankshaft (9). In the consequence of this case, the stroke length of the sliding carrier in FIG. 1 thus becomes equal to the diameter of the second curved path (10).

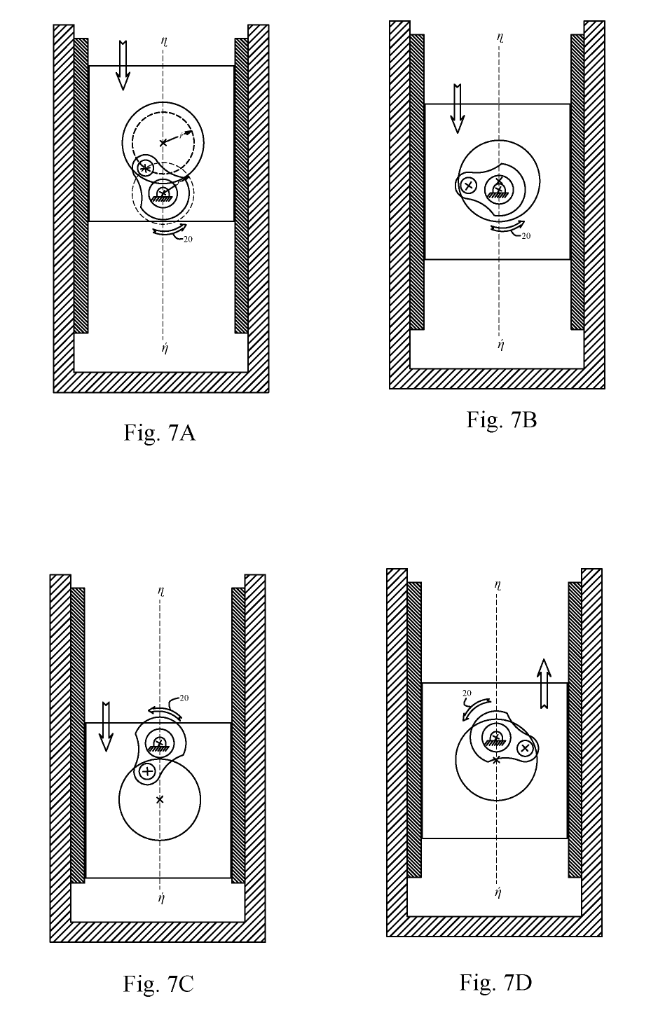

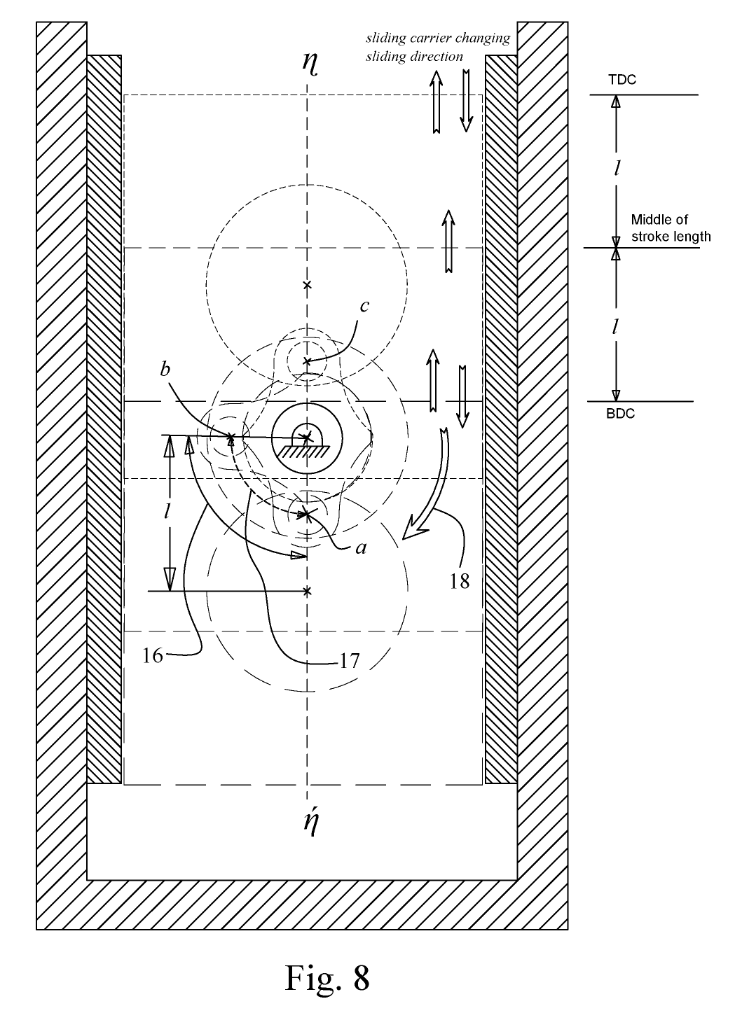

For the second case, wherein the second radius r is same as the first radius ŕ, a forward momentum traversing through the central rotational axis of connecting disk (4) is always dominant along the direction of sliding motion of sliding carrier (3) (comparing FIG. 6 with FIG. 8) because the crank pin (7) supports the connecting disk (4) eccentrically from the first axis (6) and this forward momentum is in fact the basic driving force acting parallely with the sliding motion (shown as an upward or downward arrow in FIG. 7A thru FIG. 7D) to drive the crankshaft and vice versa. The forward momentum is acting around the pivot axis (8) and consequently relevant equations are derived below to define the working principle, on the basis of above description in view of FIG. 8.

ŕ=r (1)

wherein,
ŕ=radius of 1^{st} curved path (14) travelled by the crank pin
r=radius of 2^{nd} curved path (10) travelled by the crank pin
l=half of stroke length of the sliding carrier (3)
ĺ=curved length (17) travelled by the crank pin in any quadrant
v=linear velocity of sliding carrier arising from travelling length “l” in period “t”
\acute{v}=linear velocity of connecting disk arising from travelling length “ĺ” in period “t”
So total stroke length travelled by the sliding carrier (3) is 2l=2ŕ+2r and

l=ŕ+r=2r=2ŕ (2)

and length traveled by crank pin in first quadrant,

ĺ=2πr/4

=πŕ/2 (3)

As a traveling (from “a” to “b” in FIG. 8) of crank pin in first quadrant effectuates the sliding carrier to travel half of stroke length simultaneously, therefore, a comparison between equation (1) and (2) reflects

l>ĺ, as 2ŕ>πŕ/2

So as, v>\acute{v}

i.e. the sliding carrier (3) along with connecting disk (4) travels at higher linear velocity than the crank pin in the middle of stroke length and it is obvious that a connecting disk and a sliding carrier possess more mass than crank pin and subsequently the connecting disk having a higher momentum acting across the centroid of connecting disk and helps it to being rearranged by rotation in every moment within the sliding carrier as like in FIG. 7A thru FIG. 7D or in FIG. 8. To compress a gas, a crank shaft is required to rotate at least at a minimum rotational speed as a threshold compressive force arising from a forward momentum is required at the middle of stroke length to compress the gas further and a volume of fluid (air/gas) sucked from atmosphere or from a source into a specific combustion chamber is generally constant for said combustion chamber. However after combustion, the expansion enforces the sliding carrier to travel at full stroke length with a greater flexibility compared to traditional mechanism in FIG. 7B and exhibiting less force fraction wherein this force fraction is a term which representing a split of force into two components when the force is projected on an inclined plane.

The other advantage of this system is advertently mentioned that the wear and tear rate is very low in this mechanism as the stress/pressure applied from/to sliding carrier is likely uniformly distributed on connecting disk in presence of engine oil, so a stress contraction also becomes lower, a stable and leak-proof compression or expansion can be maintained for a long period under proper sealing and thus ensures a stable operation and longer product life compared to the mechanism of traditional reciprocating and an Skotch yoke system. This mechanism basically relies on connecting the traditional crankshaft with sliding carrier by connecting member in such a way that the sliding carrier as well the connecting member act as a unified item for sliding and removing the necessity of connecting rod which is widely used in conventional reciprocating system. However the traditional Skotch yoke system may somewhat be able to improve efficiency in traditional reciprocating mechanism in the similar manner but a yoke in this system is subjected under extreme stress concentration and subsequently shortens a product life while this kind of problem is also efficiently and effectively solved by this current mechanism.

1. A mechanism for a motion conversion comprising:
an enclosure;
a sliding carrier having a sliding motion within the enclosure;
a connecting member coupled by a first pivotal coupling, having a rotational motion around a first axis, within said sliding carrier;
a crankshaft rotating around a second axis, pivotally coupled to the enclosure, transmitting a power, further comprising a crank pin wherein said crankpin coupled to the connecting member by a second pivotal coupling, rotates around a pivot axis, within the first pivotal coupling in such a way that the pivot axis is offset from both the first axis and the second axis.

2. The mechanism in claim 1 wherein the first axis, the second axis and the pivot axis, are parallel to each other.

3. The mechanism in claim 2 wherein the first axis and the second axis are aligned within a sliding plane.

4. The mechanism in claim 3 wherein the first axis is sliding within the sliding plane.

5. The mechanism in claim 4 wherein the sliding carrier is fixed with the first axis.

6. The mechanism in claim 4 wherein the second axis is fixed with the enclosure.

7. The mechanism in claim 6 wherein the pivot axis is rotating around the first axis.

8. The mechanism in claim 7 wherein the pivot axis is rotating around the second axis.

9. The mechanism in claim 8 wherein a rotation of the pivot axis around the first axis, defining a first curved path.

10. The mechanism in claim 9 wherein a radius of the connecting member, is larger than a radius of the first curved path.

11. The mechanism in claim 10 wherein a rotation of the pivot axis around the second axis, defining a second curved path.

12. The mechanism in claim 11 wherein a radius of the second curved path, is at most equal to the radius of the first curved path.
